(19) United States
(12) Patent Application Publication
(10) Pub. No.: US 2026/0100913 A1
(43) Pub. Date: Apr. 9, 2026

(54) SYSTEM AND METHOD FOR INTEGRATED WIRED-WIRELESS TIME-SENSITIVE NETWORKING

(71) Applicant: Amrita Vishwa Vidyapeetham, Kollam (IN)

(72) Inventors: Subhasri Duttagupta, Mumbai (IN); Abhilash Gopalakrishnan, Kottayam (IN)

(21) Appl. No.: 19/202,345

(22) Filed: May 8, 2025

(30) Foreign Application Priority Data
Oct. 4, 2024 (IN) 202441075275

(51) Int. Cl. H04L 47/28; H04L 41/16; H04L 47/24; H04W 28/02

(52) U.S. Cl. CPC H04L 47/28; H04L 41/16; H04L 47/2458; H04W 28/0236; H04W 28/0278

(57) ABSTRACT

The present disclosure describes a Time Sensitive Networking (TSN) network integrating wired and wireless TSN agents to ensure deterministic communication for mission-critical Internet of Things (IoT) applications. The TSN network includes the TSN agents, each configured to manage packet transmission and adjust priority classes based on flow schedules and Quality of Service (QoS) feedback report. TSN agents dynamically adapt to network conditions using feedback mechanisms, such as Buffer Status Report Polling, and Bandwidth Query Reporting. The TSN controller employs a reinforcement learning model, which is continually retrained/fine-tuned using the QoS feedback report, to generate optimized flow schedules, enhancing latency, reliability, and efficient use of resources.

### TECHNICAL FIELD

The present disclosure relates to communication networks, and more particularly to a system and method for integrating wired and wireless agents in a network to provide deterministic guarantees for time-sensitive applications.

### BACKGROUND

Communication technologies play a significant role in systems engineering across various sectors such as industrial automation, smart healthcare, and vehicular systems. The proliferation of connected embedded systems has led to the emergence of the Internet of Things (IoT) in many applications, for example. Some of these applications are safety-critical or mission-critical, posing stringent requirements for reliability and low-latency communication.

In safety-critical systems, there is very little tolerance for failures. These systems rely heavily on communication networks to achieve the required level of reliability and performance. For example, in industrial automation systems, the Quality of Control (QoC) is dependent on the Quality of Service (QoS) provided by the underlying communication network.

Existing methods for handling real-time scenarios in communication networks are often based on application-specific requirements, such as EtherCAT in industrial automation or Full Duplex Switched Ethernet (AFDX) in aviation. However, these technologies pose challenges when it comes to integration with open standards like Ethernet. Seamless integration would mean that critical flows requiring bounded latency share the same communication channel with flows having lower severity of timing constraints.

The rise of Time-Sensitive Networking (TSN) has been a major step towards ensuring highly reliable and deterministic behaviour in networks. TSN focuses on timing and synchronization, high reliability, bounded low latency, and resource management. Moreover, the TSN standard allows flows with different requirements and priorities to coexist on the same network.

While TSN has gained reasonable maturity over Ethernet and is used in industrial applications, it is yet to be fully included in/integrated in wireless standards. This presents challenges in scenarios where both wired and wireless endpoints need to communicate with deterministic guarantees (i.e., while minimizing deadline misses, packet losses, etc.). Among wireless protocols, Wireless-Fidelity (Wi-Fi) is one of the first to be considered for inclusion in time-sensitive standards.

The integration of wired and wireless networks for time-sensitive applications presents several challenges. These include supporting time-aware scheduling in wireless access points, catering to mixed traffic scenarios in hybrid networks, and ensuring deterministic behaviour across different network domains.

Therefore, there is a need for solutions that can provide deterministic guarantees in hybrid wired-wireless environments while supporting diverse traffic types and priorities.

### OBJECTS OF THE PRESENT DISCLOSURE

Some of the objects of the present disclosure, which at least one embodiment herein satisfies are listed herein below.

It is an object of the present disclosure to provide a system for generating optimized flow schedules in hybrid wired-wireless networks using a reinforcement learning model to ensure time-sensitive traffic meets strict deadlines.

It is an object of the present disclosure to provide a system and a method for dynamically adjusting traffic schedules based on real-time network performance metrics to maintain high reliability and efficiency in hybrid network environments.

It is an object of the present disclosure to provide a wired and/or wireless Time-Sensitive Networking (TSN) agents that can manage both wired and wireless traffic flows by prioritizing data, detecting deadline misses, and adjusting priority classes to ensure time-sensitive data transmission.

It is an object of the present disclosure to offer a scalable solution for time-sensitive networking that combines the benefits of both wired and wireless communications, optimizing network resources, and minimizing latency and jitter.

It is an object of the present disclosure to improve network utilization and ensure efficient data packet scheduling by leveraging deep reinforcement learning for more precise and adaptive traffic management across diverse network conditions.

### SUMMARY

Aspects of the present disclosure generally relate to communications, specifically to a Time Sensitive Networking (TSN) agent. The TSN agent includes a processor, and a memory operatively coupled to the processor, the memory includes one or more processor-executable instructions that, when executed, cause the processor to receive one or more packets from a preceding agent and, transmit the one or more packets to a succeeding TSN agent based on a flow schedule received from a TSN controller. The priority class of the one or more packets is adjusted based on at least one of, deadline misses and/or packets lost.

In an embodiment, the processor may be configured to determine/generate a Quality of Service (QoS) feedback report. The feedback report may indicate at least one of, deadline misses and/or the packets lost. Based on the QoS feedback report, the processor may be configured to, adjust the priority class of the packets, and enable a gate of a queue serving higher priority packets to be made available to the one or more packets, or drop at least one packet from the one or more packets that are likely to miss deadlines.

In an embodiment, the QoS feedback may be determined using at least one of a Buffer Status Report Polling (BSRP), a Bandwidth Query Reporting (BQR), or a Null Data Packet (NDP) Feedback report.

In an embodiment, the processor may be configured to transmit the QoS feedback report to the TSN controller, where the QoS feedback report may be used to train and/or finetune a deep reinforcement learning model used to determine the flow schedule.

In an embodiment, the preceding agent and the succeeding agent may be an access point, a wireless TSN agent, or a wired TSN agent.

In an embodiment, the processor may be further configured to assign a tag to the packet based on stream identification and encoding by the access point or the wireless TSN agent.

In an embodiment, the processor may be configured to transmit the packet through a bridge to any one of the access points, the wireless TSN agent, or the wired TSN agent, based on whether the TSN agent is wired or wireless.

In an embodiment, a TSN controller includes a processor, and a memory operatively coupled to the processor. The memory includes processor-executable instructions which, when executed, causes the processor to generate a flow schedule using a reinforcement learning model based on flow specifications and network topology. The processor then transmits the flow schedules to one or more TSN agents, which may include at least one of an access point, a wireless TSN agent, or a wired TSN agent.

In an embodiment, the deep reinforcement learning model considers a Markov Decision Process (MDP) with state space including node states in the network topology, and a feature vector including at least one of a minimum time to completion, a minimum time to completion at a hop, a minimum hops to completion and flows as action space.

In an embodiment, the reinforcement learning model may be configured to apply a negative reward to flow schedules that result in deadline misses, thereby discouraging schedules that fail to meet time-sensitive requirements, and apply a positive reward for achieving tighter schedule utilization, particularly in wired or ethernet connections within the wired-wireless network, thereby promoting more efficient use of network resources.

In another aspect, a method for transmitting packets through TSN agents includes receiving, by a TSN agent, one or more packets from a preceding TSN agent, and transmitting, by the TSN agent, the one or more packets to a succeeding TSN agent based on a flow schedule received from a TSN controller, where a priority class of the one or more packets may be adjusted based on at least one of a deadline miss or packet loss.

Various objects, features, aspects, and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings, which are incorporated herein and constitute a part of this disclosure, illustrate exemplary embodiments of the disclosed methods and systems, where like reference numerals refer to the same parts/components throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates schematic representation of a Time Sensitive Networking (TSN) network, in accordance with embodiments of the present disclosure.

FIG. 2A illustrates an example block diagram of a TSN controller, in accordance with an embodiment of the present disclosure.

FIG. 2B illustrates an example block diagram of a TSN agent, in accordance with an embodiment of the present disclosure.

FIG. 3 illustrates a flow diagram of a method for operation of the TSN network, in accordance with an embodiment of the present disclosure.

FIG. 4 illustrates an example computer system in which or with which embodiments of the TSN agent or the TSN controller may be utilized, in accordance with embodiments of the present disclosure.

The foregoing shall be more apparent from the following more detailed description of the disclosure.

### BRIEF DESCRIPTION OF THE PRESENT DISCLOSURE

In the following description, for explanation, various specific details are outlined in order to provide a thorough understanding of the embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

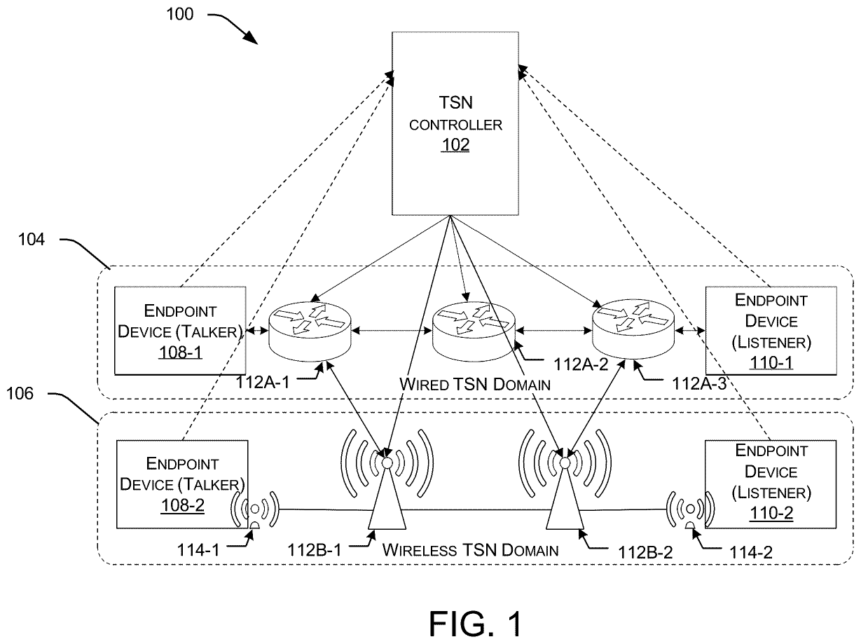

The various embodiments throughout the disclosure will be explained in more detail with reference to FIGS. 1-5.

FIG. 1 illustrates a schematic representation of a Time Sensitive Networking (TSN) network 100, which shows the integration of wired and wireless TSN agents/elements to provide deterministic guarantees for time-sensitive applications, in accordance with an embodiment of the present disclosure.

In an embodiment, the TSN network 100 includes a TSN controller 102. The TSN controller 102 may be configured to manage flow of packets through the TSN network 100. In an example, the TSN controller 102 may be configured to generate flow schedules based on network topology and flow specifications, using reinforcement learning models. In some embodiments, the TSN controller 102 may also be configured to a Central User Configuration (CUC) entity/data, which may be configured to collect information about TSN traffic within the TSN network 100. The TSN controller 102 may be configured to use the data from the CUC, for example, to perform admission control, deploy resource allocation strategies, and manage the TSN traffic to meet the required time sensitive performance. In one example, any suitable configuration and/or management protocols and/or mechanisms may be utilized by the TSN controller 102, e.g., to meet the required time sensitive performance.

In an embodiment, the TSN network 100 may also include a wired TSN domain 104. In an example, the wired TSN domain 104 may include wired connections and components, such as of wired TSN agents (e.g., TSN agents 112A-1 to 112A-3, collectively referred to as wired TSN agents 112A). Further, in an embodiment, the TSN network 100 may also include a wireless TSN domain 106. In an example, the wireless TSN domain 106 may include wireless connections and components, such as wireless TSN agents (e.g., TSN agents 112B-1 and 112B-2, collectively referred to as wireless TSN agents 112B). The TSN agents (whether wired or wireless, which are collectively referred to as TSN agents 112), may be configured to receive and transmit one or more data packets from a source device to a destination device within the TSN network 100.

In an embodiment, the TSN network 100 may also include endpoint devices 108-1 to 108-2, and 110-1 and 110-2, which are collectively referred to as endpoint devices 108 and 110, respectively. In an example, the endpoint devices 108, 110 may be present in both the wired TSN domain 104 and the wireless TSN domain 106 and act as data sources (talkers) or destinations (listeners) for time-sensitive applications. For example, the talkers may be video cameras, and the listeners may be remote surgery devices operated by medical professionals. Given the time sensitive nature of such applications, low latency, minimal packet losses, and deterministic transmission of packets are desirable.

In an example, the TSN agents 112 may be implemented as, or associated with, intermediary components/switches/routers/wireless-fidelity (Wi-Fi) hosts that receive and transmit packets based on the flow schedules from the TSN controller 102. In an example, the TSN agents 112 may be configured to adjust packet priorities based on Quality of Service (QoS) feedback report. In an embodiment, the TSN network 100 may include one or more access points 114-1, 114-2 (referred to as 114), which may extend the range of the TSN network 100. In an example, the wireless TSN access points 114 may be configured to facilitate communication between the TSN agents 112 and the endpoint devices 108, 110, thereby enabling the endpoint devices 108, 110 to communicate through the TSN network 100 in a time sensitive paradigm.

In an operation, the TSN controller 102 may be configured to coordinate communication between the endpoint devices 108-1 and 108-2, 110-1 and 110-2 across both the wired TSN domain 104 and the wireless TSN domain 106. The TSN controller 102 may be configured to generate and distribute the flow schedules to ensure deterministic performance across the entire network.

In some embodiments, the flow schedule may be generated based on the CUC data (which may be configured by users/operators of the TSN network 100 and/or the endpoint devices 108, 110), flow specifications (which indicates the number of packets to be transmitted, the destination of the packets, and the like, from the endpoint devices 108, 110), and the topology of the TSN network 100. The flow specification may also specify the priority and deadline of each packet. Further, streams may be identified from the flows in the flow specifications. The streams may correspond to flows having a data type and a priority mapped thereto. In an example, the flow specification may include various types of data streams with different priority levels and deadlines. For example, the flow specification may include a video data stream, vitals data stream, and a monitoring data stream. The video data stream may have a priority of 4 and a deadline of 200 ms, indicating its high importance and strict timing requirements. The vitals data stream may have a priority of 3 and a deadline of 250 ms, reflecting its critical nature but slightly less stringent timing compared to video. The monitoring data stream may have a priority of 1 and a deadline of 500 ms, suggesting lower urgency but still requiring timely delivery within the specified timeframe. These flow specifications enable the TSN controller 102 to generate appropriate flow schedules that meet the diverse requirements of different data types in the network.

In some embodiments, the flow schedule may be generated as a Gate Control List (GCLs). The flow schedule, once generated, may be provided to all the TSN agents 112 in the network 100. Time shaper modules/engines at each of the TSN agents 112 may be configured to use the GCLs to selectively open and/or close gates associated with queues maintained for each priority class of the packets (as may be configured and specified in the CUC data).

This allows the TSN network 100 to provide deterministic guarantees for time-sensitive applications across both wired and wireless domains 104, 106 of the network 100, addressing the challenges of maintaining strict timing requirements in diverse network environments.

Although FIG. 1 shows exemplary components of the TSN network 100, in other embodiments, the TSN network 100 may include fewer components, different components, differently arranged components, or additional functional components than depicted in FIG. 1. Additionally, or alternatively, one or more components of the TSN network 100 may perform functions described as being performed by one or more other components of the TSN network 100. The TSN network 100 may be suitably adapted based on the requirements.

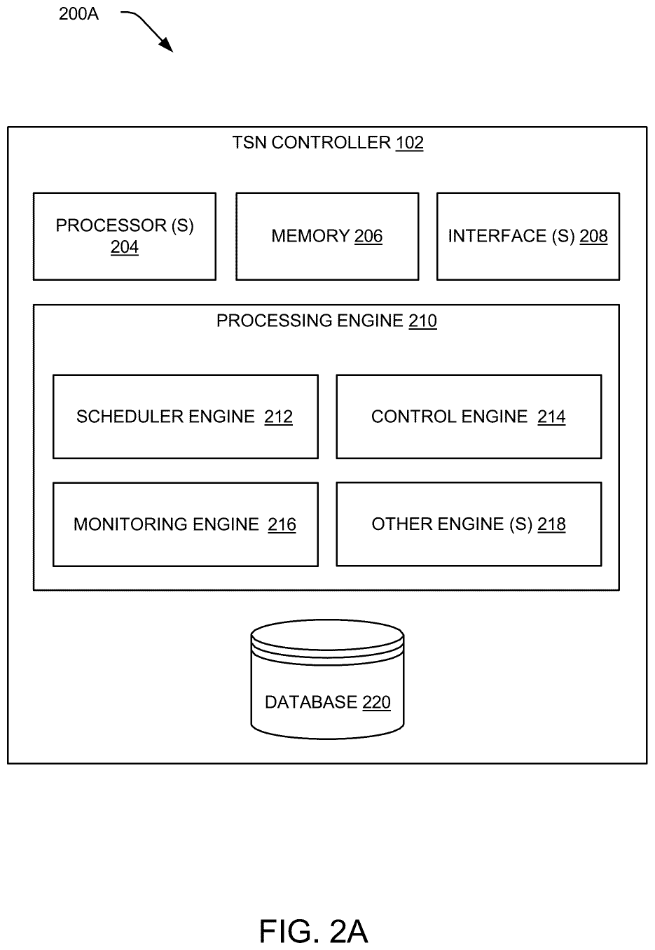

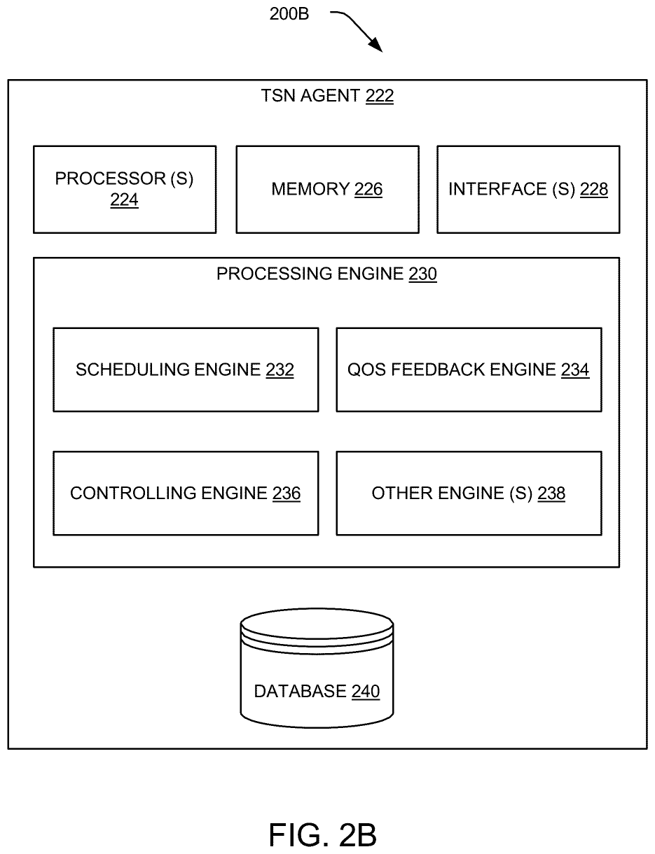

FIG. 2A illustrates an example block diagram 200A of a TSN controller 102, in accordance with an embodiment of the present disclosure. In an example, the TSN controller 102 is similar to the TSN controller 102 explained in reference to FIG. 1.

With reference to FIG. 2A, the TSN controller 102 may include one or more processor(s) 204 that may be implemented as one or more microprocessors, microcomputers, microcontrollers, digital signal processors, central processing units, logic circuitries, and/or any devices that process data based on operational instructions. Among other capabilities, the one or more processor(s) 204 may be configured to fetch and execute computer-readable instructions stored in a memory 206 of the TSN controller 102. The memory 206 may be configured to store one or more computer-readable instructions or routines in a non-transitory computer-readable storage medium, which may be fetched and executed to create or share data packets over a network service. The memory 206 may include any non-transitory storage device including, for example, volatile memory such as random-access memory (RAM), or non-volatile memory such as erasable programmable read-only memory (EPROM), flash memory, and the like.

In an embodiment, the TSN controller 102 may include an interface(s) 208. The interface(s) 208 may include a variety of interfaces, for example, interfaces for data input and output (I/O) devices, storage devices, and the like. The interface(s) 208 may also provide a communication pathway for one or more components of the TSN controller 102. Examples of such components include, but are not limited to, processing engine(s) 210 and a database 220, where the processing engine(s) 210 may include, but not be limited to, a scheduler engine 212, a control engine 214, a monitoring engine 216, and other engine(s) 218. The other engine(s) 218 may be configured to facilitate other operations of the TSN controller 102.

In an embodiment, the processing engine(s) 210 may be implemented as a combination of hardware and software/programming (for example, programmable instructions) to implement one or more functionalities of the processing engine(s) 210. In examples described herein, such combinations of hardware and programming may be implemented in several different ways. For example, the software/programming for the processing engine(s) 210 may be processor-executable instructions stored on a non-transitory machine-readable storage medium and the hardware for the processing engine(s) 210 may include a processing resource (for example, one or more processors), to execute such instructions.

In the present examples, the computer-readable storage medium may store instructions that, when executed by the processing resource, implement the processing engine(s) 210. In such examples, the TSN controller 102 may include the computer-readable storage medium storing the instructions and the processing resource to execute the instructions, or the computer-readable storage medium may be separate but accessible to the TSN controller 102 and the processing resource. In other examples, the processing engine(s) 210 may be implemented by electronic circuitry.

In an embodiment, the processor 204, via the scheduler engine 212, may be configured to generate flow schedules that govern the transmission of time-sensitive data across a wired-wireless hybrid network, such as the TSN network 100. In an example, the TSN network 100 may be an Ethernet-Wi-Fi network, as indicated by the use of wired TSN agents 112A (which may use Ethernet protocols) and wireless TSN agents 112B (which use Wi-Fi protocols). In an embodiment, the scheduler engine 212 may be configured to use a reinforcement learning model to create optimal schedules based on flow specifications and network topology of the TSN network 100. The flow specifications may be provided by the endpoint devices 108, 110. In an example, the reinforcement learning model used by the scheduler engine 212 may be designed to continuously improve its scheduling decisions. The reinforcement learning model may apply a system of rewards and penalties to refine its output. For example, the reinforcement learning model may assign negative rewards to the flow schedules that result in deadline misses, thereby discouraging schedules that fail to meet time-sensitive requirements. Conversely, the reinforcement learning model may apply positive rewards for achieving tighter schedule utilization, thereby promoting more efficient use of network resources.

In an embodiment, the reinforcement learning model may be implemented as Markov Decision Process (MDP). The state space of the MDP may include node states (or states of the TSN agent 112, the endpoints 108, 110, the access points 114, and the like) in the network topology, providing a comprehensive view of current condition of the TSN network 100. The feature vector used in the reinforcement learning model may include parameters such as minimum time to completion, minimum time to completion at a hop, minimum hops to completion, and flows as action space. This allows the reinforcement learning model to make informed decisions based on a holistic understanding of the state and requirements of the network topology.

In an embodiment, the scheduler engine 212 may be configured with a wireless-aware compensating factor. In an example, the wireless-aware compensating factor may account for the inherent uncertainties in wireless medium timing. The reward design encourages tighter schedule utilization in wired/Ethernet segments to compensate for potential delays in wireless segments due to fading and congestion effects. The reinforcement learning model may adjust this compensation based on the Wi-Fi standard in use, with Wi-Fi 6E or higher receiving different consideration than older standards. Additionally, the scheduler engine 212 may factor in delays caused by domain translation between wired and wireless segments.

In an embodiment, the control engine 214 may be configured to implement the decisions made by the scheduler engine 212. In an example, the control engine 214 may be configured to transmit the generated flow schedules to one or more TSN agents, such as the TSN agent 112, distributed throughout the TSN network 100. In some embodiments, when the packets are transmitted to TSN agents 112 in different domains, such as from wireless TSN agents 112B to wired TSN agents 112A, or vice-versa, a bridge may be used for domain conversions or translations to reflect the change in domains (such as through use of tags (e.g., IEEE 802.1Q tags), Frame Check Sequence, timing information, and the like).

In an example, the control engine 214 may be configured to also adjust packet priorities in real-time based on network conditions, managing network resources to ensure optimal performance, and ensuring compliance with TSN standards across both wired and wireless domains. In some embodiments, the control engine 214 may be configured to receive QoS feedback from the TSN agents 112 in the TSN network 100, which may be used for the parameters of the reinforcement learning model, particularly the reward function, thereby improving its performance and dynamically adapting the flow schedules generated based on real-time network conditions.

In an example, the monitoring engine 216 may be configured to continuously observe network status, using mechanisms/reports such as Wi-Fi Buffer Status Report Poll (BSRP), Bandwidth Query Reporting (BQR), and Null Data Packet (NDP) feedback report polling. These tools may provide insights into buffer capabilities, subchannel availability, and overall network performance across both wired and wireless domains, which may be subsequently used by the scheduler engine 212 for dynamically updating parameters of the reinforcement model.

In an example, the monitoring engine 216 may be configured to detect early signs of performance issues, such as packets missing deadlines. When such issues are detected, the monitoring engine 216 may work in conjunction with the control engine 214 to perform root cause analysis. Based on these insights, the scheduler engine 212 may dynamically adjust a priority class or Priority Code Point (PCP) values assigned to the packets, such as to enable gates serving higher priority traffic to be made available to the packets associated with streams experiencing deadline misses and/or packet losses. This ensures that critical traffic meets its deadlines, even in challenging network conditions.

Although FIG. 2A shows some components of the TSN controller 102, in other embodiments, the TSN controller 102 may include fewer components, different components, differently arranged components, or additional functional components than depicted in FIG. 2A. Additionally, or alternatively, one or more components of the TSN controller 102 may perform functions described as being performed by one or more other components of the TSN controller 102.

FIG. 2B illustrates an example block diagram 200B of a TSN agent 112, in accordance with an embodiment of the present disclosure.

With reference to FIG. 2B, the TSN agent 112 may include one or more processor(s) 224 that may be implemented similarly to the processor 204, in terms of structure/hardware. Among other capabilities, the one or more processor(s) 224 may be configured to fetch and execute computer-readable instructions stored in a memory 226 of the TSN agent 112. The memory 226 may be configured to store one or more computer-readable instructions or routines in a non-transitory computer-readable storage medium, which may be fetched and executed to create or share data packets over a network service. The memory 226 may implemented similarly to the memory 206, in terms of structure/hardware.

Further, the TSN agent 112 may include an interface(s) 228, processing engine(s) 230 and a database 240, which may also be implemented similarly to the interface(s) 208, the processing engines 210, and the database 220 of FIG. 2B, respectively, in terms of structure/hardware. The processing engine(s) 230 of the TSN agent 112 may include, but not be limited to, a scheduling engine 232, a QoS feedback engine 234, a controlling engine 236, and other engine(s) 238. The other engine(s) 238 may include, but is not limited to, a control engine, and the like.

In an embodiment, the processor 224, via the scheduling engine 232, may be configured to implement the flow schedules received from the TSN controller 102. The scheduling engine 232 may be configured to manage the timing and routing of packets based on these predetermined schedules, ensuring that time-sensitive data is transmitted according to the requirements of the TSN network 100. In an example, upon receiving a flow schedule from the TSN controller 102, the scheduling engine 232 may interpret and translate the flow schedule into actionable instructions for packet handling. The scheduling engine 232 may, using the flow schedule) determine when specific packets should be transmitted, through which ports, and with what priority. The scheduling engine 232 may be configured to work with the hardware queues and traffic shapers to ensure that packets are transmitted according to the flow schedule.

In an embodiment, the scheduling engine 232 may also be configured to handle the complexities of dealing with different types of network traffic. The scheduling engine 232 may balance the strict timing requirements of time-sensitive data with the needs of best-effort traffic. This involves managing multiple queues and implementing sophisticated packet selection algorithms to maintain the overall flow schedule while adapting to real-time network conditions.

In an embodiment, the QoS feedback engine 234 may be configured to determine QoS feedback, which may include critical information about deadline misses and packet losses. The QoS feedback engine 234 may assess the ability of the TSN network 100 to meet its time-sensitive commitments. To gather this information, the QoS feedback engine 234 may employ various mechanisms/reports that may include, but not limited to, BSRP, BQR, NDP feedback reports, and the like. In an example, the BSRP may allow the QoS feedback engine 234 to check the buffer capability of stations or hosts, providing insight into the amount of data queued at each point. In an example, the BQR may provide feedback on available subchannels at stations or hosts, while NDP feedback report polling may be useful for scenarios involving multiple stations or hosts, as it provides shorter feedback.

In an example, the QoS feedback engine 234 may be also configured to process and analyze the QoS feedback report to identify trends and potential issues. In an example, the QoS feedback engine 234 may use statistical methods to detect patterns in deadline misses or packet losses that may indicate underlying problems in the TSN network 100. This processed information may be then made available to other components of the TSN agent 112 and, also may be transmitted back to the TSN controller 102 for use in optimizing the overall network performance.

In an embodiment, the controlling engine 236 may take the insights provided by the QoS feedback engine 234 and use them to make real-time adjustments to packet handling. In an example, the controlling engine 236 may adjust the priority class of packets based on the QoS feedback report. The reprioritization of the packets may enable the TSN agent 112 to minimize deadline misses and packet losses

In an example, when the controlling engine 236 receives information about deadline misses or packet losses, the controlling engine 236 may dynamically modify the priority of subsequent packets in the affected streams, potentially dropping at least one packet from the one or more packets that are likely to miss deadline. This adjustment helps ensure that critical data meets its timing requirements. The controlling engine 236 may implement these priority changes by interacting with the packet classification and queuing systems of the TSN agent 112

In an embodiment, the controlling engine 236 may manage GCL. In an example, the GCL may control the timing of packet transmissions. When the QoS feedback indicates potential issues, the controlling engine 236 may modify the GCL to make higher priority service available for certain packets. This may involve opening transmission gates more frequently for high-priority traffic or adjusting the duration of transmission opportunities.

In an example, the controlling engine 236 may handle traffic to and from the access points 114, wireless TSN agents 112B, and wired TSN agents 112A. The controlling engine 236 may be configured to make decisions about packet routing, applying appropriate tags or markings to packets, and ensuring that the TSN agent 112 seamlessly bridges between different network domains (e.g., wired to wireless).

In an example, the controlling engine 236 may prepare and send the QoS feedback to the TSN controller 102. This feedback is necessary for the continuous improvement of the performance of the TSN network 100. By providing detailed information about local network conditions and performance metrics, the controlling engine 236 may contribute to the fine-tuning of the reinforcement learning model used by the TSN controller 102 to generate the flow schedules.

Although FIG. 2B shows some components of the TSN agent 112, in other embodiments, the TSN agent 112 may include fewer components, different components, differently arranged components, or additional functional components than depicted in FIG. 2B. Additionally, or alternatively, one or more components of the TSN agent 112 may perform functions described as being performed by one or more other components of the TSN agent 112.

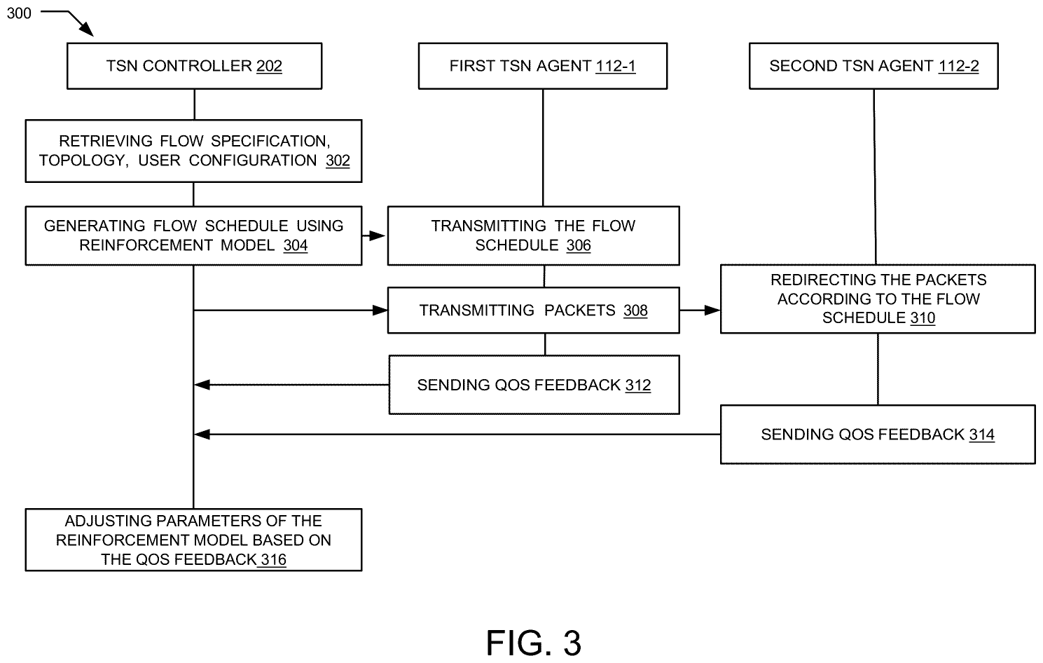

FIG. 3 illustrates a flow diagram of the TSN network 100 depicting a TSN controller and TSN agent (such as TSN controller 102 and TSN agents 112-1 and 112-2 belonging to the TSN network 100 of FIG. 1) implementing a method 300, in accordance with an embodiment of the present disclosure. The method 300 may include steps 302 to 316.

At step 302, the TSN controller 102 retrieves/receives flow specifications, topology information, and user configuration data (such as CUC). This information forms the basis for generating the flow schedule. In an example, the flow specifications may be retrieved from the endpoint devices 108, 110 that generate or receive time-sensitive data. In another example, the topology information may be gathered by the TSN controller 102. In yet another example, the user configuration data may be input directly into the TSN Controller 102 by network administrators or retrieved from the CUC.

At step 304, the TSN controller 102 generates a flow schedule using a reinforcement learning model. In an example, the reinforcement learning model may use the retrieved information, such as the flow specifications, topology information, and user configuration data to create an optimized schedule for both wired and wireless TSN domains (such as wired and wireless TSN domains 104, 106 of FIG. 1) of the TSN network 100.

At step 306, the TSN controller 102 transmits the generated flow schedule to the first TSN agent 112-1 and the second TSN agent 112-2. In some embodiments, the first TSN agent 112-1 may be a wireless agent and the second TSN agent 112-2 may be a wired agent, and vice-versa in other embodiments.

At step 308, the first TSN agent 112-1 may be configured to receive one or more packets from an endpoint (such as endpoint devices 108, which are listener endpoints). In some embodiments, the first TSN agent 112-1 may be configured to directly receive the packets from the endpoint devices 108. In other embodiments, the first TSN agent 112-1 may be configured to receive the packets from the endpoint devices 108 through an access point (such as access points 114 of FIG. 1). In further embodiments, the first TSN agent 112-1 may be configured to receive the packets from a preceding TSN agent (not shown) in the TSN network 100. In some embodiments, the received packets may be appended to corresponding queues based on priority thereof. In some embodiments, the received packets may have tags associated with them for stream identification. In other embodiments, the TSN agents 112 may be configured to encode and add tags to the packets.

At step 310, the first TSN agent 112-1 further transmits/redirects packets to the second TSN agent 102-2 according to the received flow schedule. In such embodiments, the packets from the first TSN agent 112-1, which may be the preceding TSN agent with respect to the second TSN agent 112-1, may transmit the packets to the second TSN agent 112-2, which may be succeeding TSN agent with respect to the first TSN agent 112-1. In some embodiments, gates associated with the queues maintained by the first TSN agent 112-1 may be selectively opened and/or closed based on a predetermined timing sequence, as may be defined in TSN protocols or standards known to those skilled in the art. In the second TSN agent 102-2 may further maintain corresponding queues for each priority class and use the flow schedule by the second TSN agent 102-2 further redirect the packets either to other TSN agents in the TSN network 100 (whether wired or wireless), or other endpoints (such as endpoint devices 110, which may be talker endpoints). Whenever the streams cross domains, i.e., from wired domain 104 to wireless domain 106, and/or vice versa, the packets may undergo a translation to reflect the native domain characteristics, e.g., IEEE 802.1Q tag, Frame Check Sequence, and timing information.

At step 312, the first TSN agent 112-1 and the second TSN agent 112-2 may be configured to generate a QoS feedback. In an example, the QoS feedback may include information about deadline misses, packet losses, and other performance metrics for the wired domain. The types of feedback reports included in the QoS feedback report may be any one or a combination of Wi-Fi BSRP by the access points 114, which can be used to check the buffer capability of stations/hosts. This may provide insight into amount of data queued at the host/station. Further, BQR report may provide feedback on which subchannels are available at station/host/endpoint devices 108, 110. For many stations/hosts/endpoint devices 108, 110 involved, Null Data Packet (NDP) feedback report polling may be used for its shorter feedback In some embodiments, the first TSN agent 112-1 and the second TSN agent 112-2 may be configured to utilize the QoS feedback reports to adjust the priority of the packets received, to relieve congestion or backpressure of packets at the TSN agents 112, for example, such as by enabling a gate of a queue serving higher priority packets to be made available of to the packets.

At step 314, the first and the second TSN agents 112-1, and 112-2, may be configured to transmit the QoS feedback to the TSN controller 102. While only two TSN agents 112-1,112-2 are shown in FIG. 3, it may be appreciated by those skilled in the art that the TSN network 100 may include any number of TSN agents 112, each of which may be configured to generate and transmit QoS feedback reports to the TSN controller 102.

At step 316, the TSN controller 102 may be configured to use the received QoS feedback from both the first TSN agent 112-1 and the second TSN agent 112-2 (among other TSN agents 112 in the TSN network 100) to adjust/update parameters of the reinforcement learning model. The QoS feedback report may be generated by the TSN controller 102, which includes critical information such as packet losses, deadline misses, and other network performance metrics, and the TSN agent 112 uses QoS feedback to fine-tune the reinforcement learning reward model and update the network state space. For example, a negative reward/reinforcement may be provided when the QoS reports indicate deadline misses or packet losses during the operation of the TSN agents 112 and provide a positive reward/reinforcement when the QoS feedback reports indicate that packet deadlines were met. The reinforcement learning model may, hence, be retrained/fine-tuned to generate optimized flow schedules based on the rewards/reinforcement provided thereto. Further, since the TSN controller 102 uses a reinforcement learning model instead of other artificial intelligence models, the TSN controller 102 may be configured to adapt to dynamic changes in the TSN network 100 in real-time. For example, failures and/or temporary congestions may affect the performance of the TSN network 100. This continuous learning process allows the TSN controller 102 to adapt to changing network conditions and improve its scheduling decisions over time.

The use of reinforcement learning models to dynamically optimize flow schedules while also enabling the TSN agents 112 to change priority classes of the packets based on deadline misses may allow for delays in the wireless connections/transmissions in the TSN network 100. Hence, the present disclosure offers a scalable solution for TSN that combines the benefits of both wired and wireless communications, optimizing network resources, and minimizing latency and jitter.

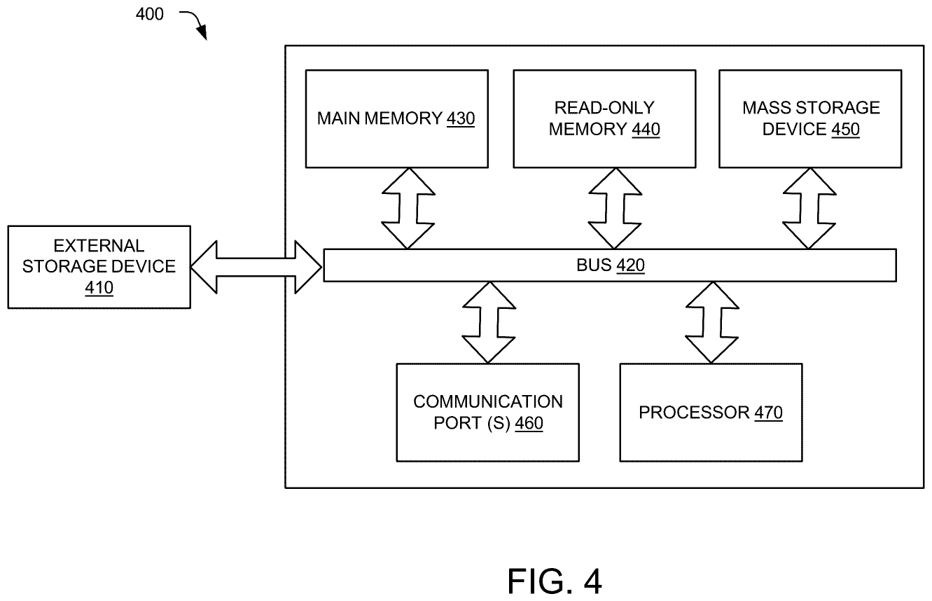

FIG. 4 illustrates an example computer system 400 in which or with which embodiments of the TSN may be utilized in accordance with embodiments of the present disclosure.

As shown in FIG. 4, the computer system 400 may include an external storage device 410, a bus 420, a main memory 430, a read-only memory 440, a mass storage device 450, a communication port(s) 460, and a processor 470. A person skilled in the art will appreciate that the computer system 400 may include more than one processor and communication ports. The communication port(s) 460 may be chosen depending on a network, such as a Local Area Network (LAN), Wide Area Network (WAN), or any network to which the computer system 400 connects. The main memory 430 may be Random Access Memory (RAM), or any other dynamic storage device commonly known in the art. The read-only memory 440 may be any static storage device(s) e.g., but not limited to, a Programmable Read Only Memory (PROM) chip for storing static information e.g., start-up or basic input/output system (BIOS) instructions for the processor 470. The mass storage device 450 may be any current or future mass storage solution, which can be used to store information and/or instructions.

The bus 420 may communicatively couple the processor 470 with the other memory, storage, and communication blocks. Optionally, operator and administrative interfaces, e.g., a display, keyboard, and cursor control device may also be coupled to the bus 420 to support direct operator interaction with the computer system 400. Other operator and administrative interfaces may be provided through network connections connected through the communication port(s) 460. In no way should the aforementioned exemplary computer system 400 limit the scope of the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions or examples, which are included to enable a person having ordinary skill in the art to make and use the present disclosure when combined with information and knowledge available to the person having ordinary skill in the art.

### Advantages of the Present Disclosure

The present disclosure improves scheduling and management of time-sensitive data within a network by ensuring deterministic communication through real-time traffic shaping and control mechanisms.

The present disclosure enhances the Quality of Service (QoS) for critical applications by using continuous feedback loops to dynamically adjust schedules, allowing for real-time responses to network conditions such as missed deadlines or packet delays.

The present disclosure optimizes the utilization of network resources through intelligent coordination between a centralized Time Sensitive Networking (TSN) controller and distributed TSN agents, ensuring that network traffic is prioritized based on both criticality and timing requirements.

The present disclosure ensures efficient traffic scheduling by utilizing a time-aware shaper that precisely controls the transmission of data packets, minimizing latency and jitter in the network.

The present disclosure enables seamless integration of wired and wireless networks by supporting both Ethernet-based TSN bridges and Wi-Fi-based endpoint devices, thereby extending the benefits of deterministic networking across hybrid network topologies.

The present disclosure allows for scalable network management through centralized control, making it easier to adjust flow schedules and QoS parameters across a large number of devices, while also supporting system-wide resource management via Buffer Status Report Polling (BSRP).

We claim:

1. A Time Sensitive Networking (TSN) agent, comprising:
a processor; and
a memory operatively coupled to the processor, the memory comprising one or more processor-executable instructions that, when executed, cause the processor to:
receive one or more packets from a preceding agent; and
transmit the one or more packets to a succeeding agent based on a flow schedule received from a TSN controller, wherein a priority class of the one or more packets is adjusted based on at least one of: deadline misses or packets lost.

2. The TSN agent of claim 1, wherein the processor is further configured to:
determine a Quality of Service (QoS) feedback report, wherein the QoS feedback report indicates at least one of: the deadline misses and/or the packets lost;
adjust the priority class of the one or more packets based on the QoS feedback report; and
enable a gate of a queue serving higher priority packets to be made available to the one or more packets,
and wherein the processor is configured to drop at least one packet from the one or more packets that are likely to miss deadlines.

3. The TSN agent of claim 2, wherein the QoS feedback report is determined using at least one of: a Buffer Status Report Polling (BSRP), a Bandwidth Query Reporting (BQR), or a Null Data Packet (NDP) feedback report.

4. The TSN agent of claim 2, wherein the processor is further configured to transmit the QoS feedback report to the TSN controller, and wherein the QoS feedback report is used to train and/or finetune a deep reinforcement learning model used to determine the flow schedule.

5. The TSN agent of claim 1, wherein the preceding agent and the succeeding agent are at least one of: an access point, a wireless TSN agent, or a wired TSN agent.

6. The TSN agent of claim 5, wherein the processor is further configured to assign a tag to each of the one or more packets based on stream identification and encoding of each of the one or more packets by the access point or the wireless TSN agent.

7. The TSN agent of claim 5, wherein the processor is further configured to transmit the one or more packets through a bridge to any one of: the access point, the wireless TSN agent, or the wired TSN agent, based on whether the TSN agent is wired or wireless.

8. A Time Sensitive Networking (TSN) controller, comprising:
a processor; and
a memory operatively coupled to the processor, wherein the memory comprises processor-executable instructions which, when executed, causes the processor to:
generate a flow schedule using a reinforcement learning model based on flow specifications and network topology; and
transmit the flow schedule to one or more TSN agents, wherein the one or more TSN agents are at least one of: an access point, a wireless TSN agent, or a wired TSN agent.

9. The TSN controller of claim 8, wherein the reinforcement learning model is configured to:
apply a negative reward to flow schedules that result in deadline misses; and
apply a positive reward to flow schedules that achieve tighter schedule utilization.

10. The TSN controller of claim 8, wherein the reinforcement learning model considers a Markov Decision Process (MDP) with state space comprising node states in the network topology, and a feature vector comprising at least one of: a minimum time to completion, a minimum time to completion at a hop, minimum hops to completion, and flows as action space.

11. A method for transmitting packets through Time Sensitive Networking (TSN) agents, comprising:
receiving, by a TSN agent, one or more packets from a preceding TSN agent; and
transmitting, by the TSN agent, the one or more packets to a succeeding TSN agent based on a flow schedule received from a TSN controller,
wherein a priority class of the one or more packets is adjusted based on at least one of: a deadline misses or packets lost.

12. The method of claim 11, further comprising:
determining a Quality of Service (QoS) feedback report, wherein the QoS feedback report indicates at least one of: the deadline misses and/or the packets lost;
adjusting the priority class of the one or more packets based on the QoS feedback report;
enabling a gate of a queue serving higher priority packets to be made available to the one or more packets, and
dropping at least one packet from the one or more packets that are likely to miss deadlines.

13. The method of claim 12, wherein determining the QoS feedback report is performed using at least one of: a Buffer Status Report Polling (BSRP), a Bandwidth Query Reporting (BQR), or a Null Data Packet (NDP) feedback report.

14. The method of claim 12, further comprising transmitting the QoS feedback report to the TSN controller, wherein the QoS feedback report is used to train and/or finetune a deep reinforcement learning model used to determine the flow schedule.

15. The method of claim 11, wherein the preceding TSN agent and the succeeding TSN agent are at least one of: an access point, a wireless TSN agent, or a wired TSN agent.

16. The method of claim 15, further comprising assigning a tag to each of the one or more packets based on stream identification and encoding of each of the one or more packets by the access point or the wireless TSN agent.

17. The method of claim 15, further comprising transmitting the one or more packets through a bridge to any one of: the access point, the wireless TSN agent, or the wired TSN agent, based on whether the TSN agent is wired or wireless.
